(19) United States
(12) Patent Application Publication
(10) Pub. No.: US 2003/0106766 A1
(43) Pub. Date: Jun. 12, 2003

(54) Power operation for opening and closing a panel and a method of controlling a power operator

(76) Inventors: Joseph M. Johnson, Troy, MI (US); Sothy Chhe, Long Beach, CA (US)

Correspondence Address: MS. KATHRYN A. MARRA, DELPHI TECHNOLOGIES, INC. LEGAL STAFF- M/C, P.O. BOX 5052, TROY, MI, 48007-5052, US

(21) Appl. No.: 10/013,155

(22) Filed: Dec. 10, 2001

(51) Int. Cl. F16D 27/14; F16D 48/06

(52) U.S. Cl. 192/103 R; 192/84.9; 192/40

(57) ABSTRACT

A power operator for opening and closing a panel including a power module that has a motor and a gear train to transfer torque from the motor to allow for movement of the panel. The power operator includes a clutch assembly that is interconnected with the gear train. The clutch assembly includes sensors for detecting an angular speed of the clutch disks. A control module is interconnected with the clutch assembly and includes a microcontroller for adjusting an engagement force of the clutch disks using pulse width modulation such that the clutch disks are maintained in a limited slip condition.

### FIELD OF THE INVENTION

The subject invention relates to power operators for vehicles for opening and closing a panel, and more particularly to a power operator for opening and closing a panel including a clutch assembly that prevents damage to the power operator when an abusive load is applied.

### BACKGROUND OF THE INVENTION

Power operators are utilized in the art for opening and closing panels such as a liftgate or a power sliding door. Clutches associated with the power operator traditionally operate in a binary mode where the clutch is either engaged to the motor to transfer torque or is stationary in an idle position. Because of the limited nature of having a clutch that is either engaged or disengaged, there is a need in the art for advanced control of a clutch mechanism that provides greater options than a binary mode clutch.

Advanced control of a clutch mechanism could be utilized to prevent damage to a power operator system. For example, an abusive load may be exerted by a user in an attempt to reverse the direction of a power operator system such as in a power operated liftgate. In this situation, the load would force the clutch to slip during full engagement, possibly leading to permanent damage of the clutch and the liftgate mechanism.

Therefore, there is a need in the art for a power operator system that includes a clutch mechanism with advanced control, such that the clutch may operate in a mode other than in a fully engaged or fully disengaged mode as with the binary clutch.

### SUMMARY OF THE INVENTION

A power operator for opening and closing a panel including a power module that has a motor and a gear train for transferring torque from the motor to move the panel. There is also included a clutch assembly interconnected with the gear train. The clutch assembly includes sensors for detecting an angular speed of clutch disks associated with the clutch assembly. A control panel is interconnected with the clutch assembly and includes a microcontroller for adjusting an engagement force of the clutch disks utilizing pulse width modulation, such that the clutch disks are maintained in a limited slip condition.

There is also disclosed a method of controlling a power operator including the steps of:

(a) providing a clutch assembly having sensors for detecting a relative angular speed of clutch disks associated with the clutch assembly;

(b) interconnected providing a control module including a microcontroller with the clutch assembly;

(c) detecting a first angular speed of the clutch disks using the sensors;

(d) assigning the first relative angular speed as a reference constant;

(e) detecting a second relative angular speed of the clutch disks using the sensors;

(f) calculating an error term by comparing the second relative angular speed with the reference constant;

(g) adjusting an engagement force of the clutch disks using the control module based upon the magnitude of the error term calculated;

(h) repeating steps (c) through (g).

### BRIEF DESCRIPTION OF THE DRAWINGS

FIG. 1 is a perspective view detailing the power operator of the present invention.

FIG. 2 is a perspective view detailing the clutch assembly of the power operator of the present invention.

FIG. 3 is a control diagram detailing the power operator of the present invention.

### DETAILED DESCRIPTION OF THE PREFERRED EMBODIMENTS

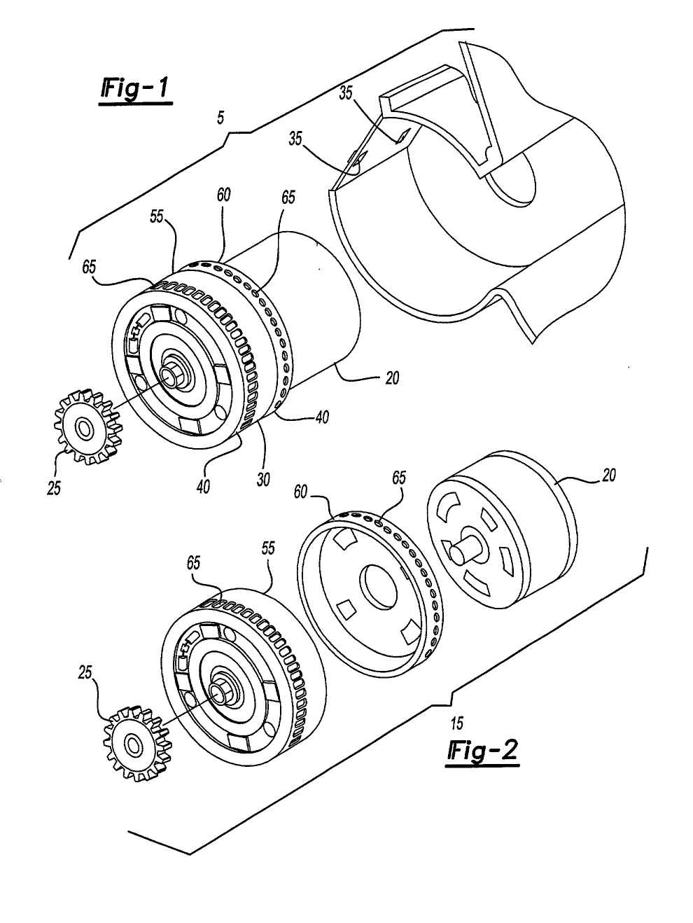

With reference to FIG. 1, there is shown the power operator 5 for opening and closing a panel.

The power operator 5 includes a motor 20 and a gear train 25 for transferring torque from the motor 20 to allow for movement of the panel.

In the pictured preferred embodiment of FIG. 1, there is shown a clutch assembly 30 interconnected with the gear train 25. The gear train 25 preferably includes gears aligned for conjugate action to allow for the movement of a panel, although only the gear associated with the clutch 30 is detailed in FIG. 1. The clutch assembly includes sensors 35 for detecting an angular speed of the clutch disks 40 associated with the clutch assembly 30.

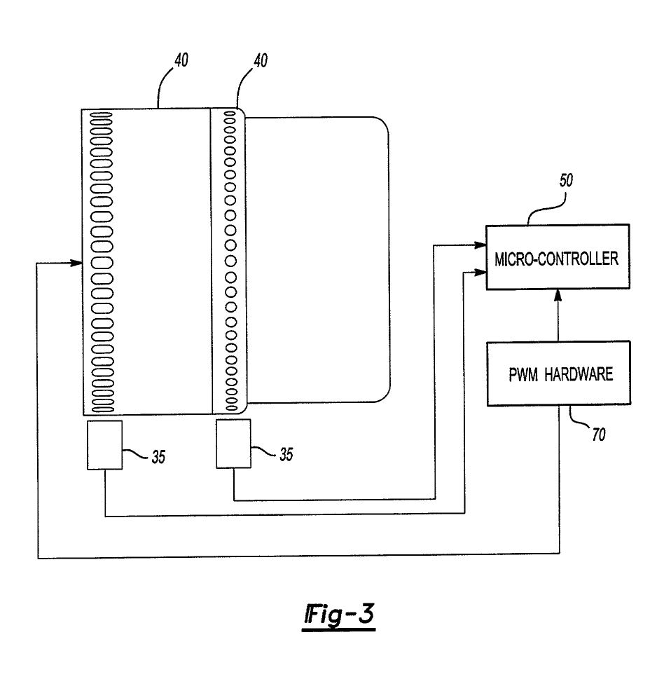

With reference to FIG. 3, a microcontroller 50 is interconnected with the clutch assembly 30. The microcontroller 50 adjusts an engagement force of the clutch disks 40 utilizing pulse width modulation such that the clutch disks 40 are maintained in a limited slip condition.

The limited slip condition is defined by a difference between a static friction condition and a dynamic friction condition. A static friction condition refers to a situation wherein the clutch disks 40 do not slide over each other but rather are locked in a no slip condition. A dynamic friction condition refers to a situation wherein the clutch disks 40 are sliding past or over each other, as the force parallel to the surface of contact is greater than the force normal to the surface of the contact. Static and dynamic coefficients of friction may be used to define the boundaries of the limited slip region of the clutch disks 40.

If a large force is applied while the clutch is in operation, the limited slip condition of the clutch disks 40 allows for the disks 40 to slip easier than if the clutch disks were maintained in a static frictional relationship. Because the force required to place the clutch disks in a slip relationship is less in a limited slip condition than in a static friction condition, damage to the clutch and other components of the power operator 5 can be avoided.

With reference to FIGS. 1 and 2, in a preferred embodiment the clutch assembly 30 is an electromagnetic clutch assembly including a rotor 55 and stator 60. The rotor 55 and stator 60 include grooves 65 formed around a periphery that are used to detect an angular speed of the clutch disks 40. The sensors 35 associated with the clutch assembly 30 are preferably hall-effect sensors that detect a magnetic flux that is generated by the grooves 65 formed on the rotor 55 and stator 60 as the motor 20 turns. As can be seen from FIGS. 1 and 2, the sensors 35 are integral with the clutch assembly 30 thereby limiting the number of components, such as a separate optical sensor (not shown), that would be utilized to detect the angular speed of the clutch disks 40.

With reference to FIG. 3, the control module 50 maintains the limited slip condition by increasing or decreasing an engagement force between the clutch disks 40 such that a specified slip rate is maintained. When the sensors 35 detect an increase in slip rate between the clutch disks 40, the control module 50 decreases an amount of current to the clutch assembly 30 thereby lessening the engagement force of the clutch disks 40 to prevent damage to the power operator 5. In this manner, the power operator 5 prevents damage to itself from an abusive load or from an obstacle placed in the path of a panel. The control module 50 then re-engages the clutch assembly 30 by increasing an amount of current after a specified time period has elapsed, which is set according to the use of the power operator 5.

As can be seen in FIG. 3, the sensors 45 associated with the clutch disks 40 send an input to the microcontroller 50 which adjusts the pulse width modulation through an appropriate pulse width modulation hardware 70. The current to the clutch is thereby increased or decreased based on the circumstances.

With reference to the method of the present invention, there is detailed the steps of a method of controlling a power operator. The preferred embodiment of the power operator 5 described above is provided in the preliminary steps A and B of the method. In step C, a first relative angular speed of the clutch disks 40 is detected utilizing the sensors 35. The first relative angular speed is assigned in step D as a reference constant. Next, a second relative angular speed is detected utilizing the sensors 35. In step F, an error term is calculated by comparing the second relative angular speed with the reference constant. In step G, an engagement force of the clutch disks 40 is adjusted utilizing the control module 50 with the appropriate pulse width modulation hardware 70 based upon the magnitude of the error term calculated in step F. Steps C through G are then repeated.

The method of controlling a power operator 5 includes adjusting an engagement force of the clutch disks 40 such that they are maintained in a limited slip condition, as defined above. The method of controlling a power operator also includes decreasing the current to the clutch assembly 30 when a large error term, indicating a large slip rate between the clutch disks 40, to disengage the clutch assembly 30 and prevent damage to components of the power operator 5.

While a preferred embodiment is disclosed, a worker in this art would understand that various modifications would come within the scope of the invention. Thus, the following claims should be studied to determine the true scope and content of this invention.

What is claimed is:

1. A power operator for opening and closing a panel comprising:
a power module including a motor and a gear train for transferring torque from the motor to move the panel;
a clutch assembly interconnected with the gear train, the clutch assembly including sensors for detecting an angular speed of clutch disks associated with the clutch assembly;
a control module interconnected with the clutch assembly, the control module including a microcontroller for adjusting an engagement force of the clutch disks using pulse width modulation such that the clutch disks are maintained in a limited slip condition.

2. The power operator of claim 1 wherein the limited slip condition is maintained by adjusting a current to the clutch assembly such that the clutch disks are in a condition defined by a difference between a static friction condition and a dynamic friction condition.

3. The power operator of claim 1 wherein the control module maintains the clutch disks in a limited slip condition by increasing or decreasing an engagement force between the clutch disks to maintain a specified slip rate.

4. The power operator of claim 1 wherein the control module decreases an amount of current to the clutch assembly, thereby disengaging the clutch and preventing damage to the power operator when the sensors detect an increase in a slip rate between the clutch disks.

5. The power operator of claim 4 wherein the control module reengages the clutch assembly by increasing the current after a sufficient time period has elapsed.

6. The power operator of claim 1 wherein the clutch assembly is an electromagnetic clutch assembly having a rotor and stator.

7. The power operator of claim 6 wherein the rotor and stator include grooves formed around a periphery of the rotor and stator.

8. The power operator of claim 6 wherein the sensors are hall-effect sensors.

9. The power operator of claim 7 wherein the hall-effect sensors detect a magnetic flux generated by the grooves as the motor turns.

10. The power operator of claim 1 wherein the sensors are integral with the clutch assembly thereby limiting the number of components of the clutch assembly.

11. A power operator for opening and closing a panel comprising:
a power module including a motor and a gear train for transferring torque from the motor to move the panel;
a clutch assembly interconnected with the gear train, the clutch assembly including sensors for detecting an angular speed of clutch disks associated with the clutch assembly;
a control module interconnected with the clutch assembly, the control module including a microcontroller for adjusting an engagement force of the clutch disks using pulse width modulation such that the clutch disks are maintained in a limited slip condition by increasing or decreasing an engagement force between the clutch disks to maintain a specified slip rate.

12. A method of controlling a power operator comprising the steps of:
a) providing a clutch assembly having sensors for detecting an angular speed of clutch disks associated with the clutch assembly;
b) providing a control module including a microcontroller interconnected with the clutch assembly;
c) detecting a first relative angular speed of the clutch disks using the sensors;
d) assigning the first relative angular speed as a reference constant;
e) detecting a second relative angular speed of the clutch disks using the sensors;
f) calculating an error term by comparing the second relative angular speed with the reference constant;
g) adjusting an engagement force of the clutch disks using the control module based upon the magnitude of the error term calculated;
h) repeating steps c) through g).

13. The method of controlling a power operator of claim 12 wherein the engagement force of the clutch disks is adjusted such that the disks are maintained in a limited slip condition.

14. The method of controlling a power operator of claim 13 wherein the engagement force of the clutch disks is adjusted by increasing or decreasing a current to the clutch assembly using pulse width modulation.

15. The method of controlling a power operator of claim 14 wherein the current to the clutch assembly is decreased, thereby disengaging the clutch assembly and preventing damage to the clutch assembly when the calculated error term is large indicating a large slip rate between the clutch disks.

16. The method of controlling a power operator of claim 12 wherein the clutch assembly is an electromagnetic clutch assembly.

17. The method of controlling a power operator of claim 12 wherein the sensors are hall-effect sensors.
